(19) United States
(12) Patent Application Publication
(10) Pub. No.: US 2013/0073615 A1
(43) Pub. Date: Mar. 21, 2013

(54) PRIVATE NETWORK WITH ENHANCED USER EXPERIENCE

(71) Applicant: OnSite Concierge, a Nevada company, South Las Vegas, NV (US)

(72) Inventors: Richard M. Hall, Henderson, NV (US); Jeremy R. Watkins, San Francisco, CA (US); Joshua J.H. Hansen, Henderson, NV (US); John G. Pretto, Boulder City, NV (US); Pedro Cardoso, Indianapolis, IN (US); Jason E. Rasberry, Henderson, NV (US)

(73) Assignee: OnSite Concierge, a Nevada company, South Las Vegas, NV (US)

(21) Appl. No.: 13/675,817

(22) Filed: Nov. 13, 2012

Related U.S. Application Data
(63) Continuation-in-part of application No. 13/562,241, filed on Jul. 30, 2012.
Application No. 13/562,241 is a continuation-in-part of application No. 12/873,255, filed on Aug. 31, 2010.
(60) Provisional application No. 61/559,241, filed on Nov. 14, 2011.

(51) Int. Cl. G06F 15/16

(52) U.S. Cl. 709/203

(57) ABSTRACT

A private network comprising a repository server and a proxy server configured to work with a client-side web server to manage the presentation of content to users of the network.

### RELATED APPLICATIONS

This application is based on and claims priority to U.S. Provisional Application No. 61/559,241, filed on Nov. 14, 2011, U.S. Non-Provisional application Ser. No. 13/562,241 filed on Jul. 30, 2012, and to U.S. Non-Provisional application Ser. No. 12/873,255, filed Aug. 31, 2010, which itself is based upon and claims priority to U.S. Provisional Application No. 61/275,346, filed on Aug. 31, 2009, the entire contents of all of which is hereby expressly incorporated by reference.

### BACKGROUND

The embodiments herein relate generally to a system for providing a network hosted locally or remotely to bring more useful content to users and enhance the experience of users in comparison to existing networks.

By way of background, a computer network, often simply referred to as a network, is a collection of hardware components, computers and other network capable devices interconnected by communication channels that allow for the sharing of resources and information between one another. Computer networks can be classified according to the physical connection types and protocols that are used to interconnect the individual devices on the network. Physical connection types include copper wiring, optical fiber, wireless radio and infrared. Protocols include Ethernet and TCP/IP. Devices include computers, smart phones, switches and routers as well as wireless access points and bridges.

A network typically allows interactive communication between multiple parties to permit an exchange of information between users. The users may access a network through their own computerized device, whether it is a personal computer, personal digital assistant, or smart phone. Public networks are generally accessible to all users, while private networks are limited to a subset of users who have authorized access following certain protocol, whether bureaucratic, such as receiving permission from the network operator to connect; technical, such as a username and password; or otherwise. A network provider will often configure the network with certain rules that govern how users and devices may communicate within and without the network they are connected to.

The Internet is an example of a global network, hosted, maintained and operated by numerous entities and accessible to virtually anyone. Many networks are smaller in scope and are referred to as local area networks (LANs). A local network may be limited to an exchange of information only amongst users within the network, or may permit connection to the Internet as well. For example, a local area network permits communication among locally connected devices including computers and personal digital assistants, as well as peripheral equipment such as printers, fax machines, telephones, scanners, and video game consoles. A local area network is typically geographically limited to a home or office building, although technically it is only limited by access to a physical connect, wired or wireless. There is often but not always a central computer to which the other computers (and peripherals) in the local area network communicate with, either in a wired or wireless fashion; although both may be employed within a single the network. In some circumstances, efficiency of information exchange dictates creating sub-networks within a company or other definable subgroups of users. In that case, a backbone network may be employed that provides a base infrastructure for the mass exchange of information between sub-networks so that such information be more easily accessed by users within a sub-network. A backbone network allows a company with diverse office locations to share information readily across great geographical distances but still within a private network setting.

The complex communications infrastructure of the Internet consists of its hardware components and a system of software layers that control various aspects of the architecture. While the hardware can often be used to support other software systems, it is the design and the rigorous standardization process of the software architecture that characterizes the Internet and provides the foundation for its scalability and success. The principal methods of networking that enable the Internet are contained in specially designated Internet standards. Internet Standards describe a framework known as the Internet Protocol Suite. This is a model architecture that divides methods into a layered system of protocols (RFC 1122, RFC 1123). The layers correspond to the environment or scope in which their services operate. At the top is the Application Layer, the space for the application-specific networking methods used in software applications (e.g., a web browser program). Below this top layer, the Transport Layer connects applications on different hosts via the network (e.g., client-server model) with appropriate data exchange methods. Underlying these layers are core networking technologies, consisting of two layers. The Internet Layer enables computers to identify and communicate with each other via Internet Protocol (IP) addresses, and allows them to connect to one-another via intermediate (transit) networks. Lastly, at the bottom of the architecture, is a software layer, the Link Layer, that provides connectivity between hosts on the same local network link, such as a local area network (LAN) or a dial-up connection. The model, also known as TCP/IP, is designed to be independent of the underlying hardware which the model therefore does not concern itself with in any detail. Other models have been developed, such as the Open Systems Interconnection (OSI) model, but they are not compatible in the details of description, nor implementation, but many similarities exist and the TCP/IP protocols are usually included in the discussion of OSI networking

The larger the network, the more it may depend less upon local connections between computers, and more upon communications handled by common carrier companies that permit transmission of content over cable lines, telephone lines, fiber optic lines, etc., and wireless transceivers in satellites, towers and the like. It is, therefore, that discrete local networks may be connected by accessing common carrier transmission to deliver content between networks. A wide area network generally consists of a series of smaller local networks connected using common carrier transmission between such networks. Closely associated with this is a virtual private network in which private communications between a user and a private network occur over the Internet, for example.

A gateway is a component that permits communication between devices on separate networks. Information exchanged is passed through gateways, often referred to as routers, directing the information from one pathway to another. In many cases, users employ their own routers to direct information that is transmitted over cable lines, phone lines or wirelessly, to the user's device. Commonly, routers are used to allow devices on a LAN to communicate with devices on the Internet and vice versa.

It is through the gateway infrastructure that information is exchanged, with the amount of information exchanged and the rate at which information is exchanged dependent upon how robust the infrastructure is. Bandwidth is a term that is used to reflect essentially the robustness of the connections between gateways and the devices communicating through them.

In most gateway configurations, protective barriers are employed between a user and a network to ensure appropriate management of the information that is exchanged and to minimize the risk of system malfunction. In that respect, the pathway between a network and a user typically includes a firewall, which can protect against information overload, unauthorized network access, or the transmission of viruses or malware that may adversely impact not only the operation of the local network but also the users' computers and/or devices.

In use, a network provides an ability for multiple users to communicate through either their private network or through a public network, depending upon how permissions are established and large the scope of the network. A network also provides a vehicle by which a user may access content that resides on servers around the world that are publicly accessible. Many servers, of course, store confidential information to which access is limited, requiring authorized users to establish permissions (e.g., username and passwords) in order to access the information. However, countless servers store an abundance of information that is readily accessible to the public.

A web server is a server employing software to handle receipt and processing of information requests and to return to the requesting party responsive information using the HTTP protocol. Part of the role of the web server is, in response to a request for information, to search through content that is stored on the server as well as other servers from other networks in which responsive content may be stored. Most users will appreciate the sophistication of web servers in being able to almost instantaneously receive a request from a user, search content from numerous servers for information responsive to the request, and then transmit the search results back to the user. Not only do web servers provide information to users upon request, they also permit a user to store content of their own for access by others. Indeed, millions of people have created their own websites offering goods and services, blogs reflecting their thoughts and opinions, and social network pages sharing photos, videos and lifestyles.

There is another device that can be used to control the flow of information between users and servers storing information; a proxy server. Although sometimes used for location spoofing, proxy servers can also provide a valuable means to exchange information efficiently, and also to modify the content exchanged pursuant to certain rules and protocols. A proxy server acts as an intermediary between a computer storing sought after information and a user seeking to access such information. The proxy employs its own software designed to manage the requests for information, the manipulations of such information, and the transmission of manipulated information to the user. It also functions to store in cached form static content hosted on remote servers to reduce the time required to otherwise transmit such content from the remote server to the user. A firewall can be set up to force user network traffic to be directed through a proxy server.

Network infrastructure created over the last few decades, as well as the software developed to support it, has permitted almost limitless uploading of an infinite amount of information that can be shared amongst millions, if not billions, of users. For that reason, given the passage of time and the number of computer users worldwide, the amount of information perceived to be responsive to requests for information is beyond useful. Sending a search request out through the Internet often brings consternation because of the need to sort through the abundance of unhelpful information in order to reach that content which may be of use. Efforts have been made to try to filter the information provided in response to search requests, but have not yet provided the level of satisfaction that should be enjoyed by a user. Indeed, recognizing the frustration that search the Internet can cause, it would be advantageous to create a network that truly enhances a user's experience.

In that regard, some efforts have been made to geo-target users to bring more relevant information to the user. Geo-targeting is useful in internet marketing and is the method of determining the geographic location of a website visitor and delivering different content to that visitor based on his or her location, such as country, region/state, city, metro code/zip code, organization, IP address, ISP or other criteria. Nevertheless, these efforts have not succeeded in presenting a seamless and more enhanced user experience as is described below with embodiments of the present invention.

### SUMMARY OF THE INVENTION

In one embodiment, a method of managing content on a private network is provided where such method is configured to deliver at least a portion of such content to network clients based upon the relevance of such content to client users. In one example, the method comprises providing a repository server configured to receive content from one or more content providers through a content management user interface, and storing such content on the repository server for managed distribution to network clients. The method may further comprise collecting and storing on the repository server both static and dynamic user and client attributes, including behavioral history of users and clients, from the web traffic established by network users and clients during a plurality of web sessions, where the collecting of such attributes takes place throughout the entire web session and is not limited to monitoring of web traffic to a single website or to a single category of websites.

The method may also comprises providing a proxy server configured to proxy the web traffic of a network user and client during at least one web session and deciding whether to modify the web traffic, where the proxy server is further configured to modify the web traffic to include additional client-side code if a decision has been made to modify the web traffic, and then to deliver the modified web traffic to the client so that the client-side code may be executed so as to initiate a conversation between the client-side code and a web service configured to determine the most relevant content for the user, thereby matching relevant content on the network with a particular user based upon the user and/or client attributes. And preferably the method comprises presenting such relevant content to the user at least at one point throughout the web session regardless of the site being visited by the user or client at the time such relevant content is presented. In another embodiment, proxying may comprise intercepting the web traffic.

In one embodiment, a private network is provided that is configured to deliver at least a portion of such content to network clients based upon the relevance of such content to client users. In one example, the private network comprises a repository server configured (i) to receive content from one or more content providers through a content management user interface, and to store such content on the repository server for managed distribution to network clients, (ii) to collect and store on the repository server both static and dynamic user and client attributes, including behavioral history of users and clients, from the web traffic established by network users and clients during a plurality of web sessions, where the collecting of such attributes takes place throughout the entire web session and is not limited to monitoring of web traffic to a single website or to a single category of websites. The private network further comprises a proxy server configured to proxy the web traffic of a network user and client during at least one web session and to decide whether to modify the web traffic, where the proxy server is further configured to modify the web traffic to include additional client-side code if a decision has been made to modify the web traffic, and then to deliver the modified web traffic to the client so that the client-side code may be executed so as to initiate a conversation between the client-side code and a web service configured to determine the most relevant content for the user, thereby matching relevant content on the network with a particular user based upon the user and/or client attributes; wherein the private network is configured to present such relevant content to the user at least at one point throughout the web session regardless of the site being visited by the user or client at the time such relevant content is presented.

In other embodiments, the network may further comprise at least one transceiver configured to permit the delivery of dynamic content to users within a locale defined by an area within range of the at least one transceiver. In yet other embodiments, a plurality of transceivers may be provided that are configured to permit the delivery of dynamic content to users within a locale defined by the position of the plurality of transceivers.

### BRIEF DESCRIPTION OF THE FIGURES

Certain embodiments of the invention are described below and illustrated in the accompanying figures by way of example. Specifically,

FIG. 1 shows schematically one embodiment of an inventive private network;

FIG. 2 shows schematically another embodiment of an inventive private network;

FIG. 3 shows schematically yet another embodiment of an inventive private network;

FIG. 4 shows one example of a dashboard graphic presentable to a user of a private network embodiment such as those described herein;

FIGS. 5 and 6 show one example of how a web page may be modified seamlessly using one of a number of private network embodiments such as those described herein;

FIG. 7 shows one example of a graphic presentation of emergency-type information where such content is provided by, for example, a government agency;

FIGS. 8A through 8F show one example of a graphic presentation of a content management interface, including examples of available menu items and the type of information associated with each menu item;

FIGS. 9A through 9E show multiple examples of how content may be presented differently depending upon the type of client device being used on the network, including for example, a tablet (FIG. 9A), a desktop (FIG. 9B) and a smart phone (FIGS. 9C-9E), the later of which also shows a feature of scrolling shelving as one graphic for the presentation of content.

### DETAILED DESCRIPTION OF CERTAIN EMBODIMENTS

Embodiments of the invention comprise a network that itself comprises first a system architecture for controlling and directing the delivery of content to a client (computer-based system used by a user) and second a web application that functions as a management interface that allows the network owner to control the content that network users receive. The web application interface functionally enables the creation, publishing, and management of rich, interactive, multichannel customer experiences on controlled high speed Internet (HSIA) and Wi-Fi networks. Embodiments of the web application drive os integrated technologies include a real-time portal customization, content curation and inventory creation, ad and content decisioning engine, enterprise search curation, content syndication, rules-based or algorithm-based on command communication and alert notification.

The system architecture encompasses process, delivery, and customer intelligence integration that includes content creation and targeting, multi-channel delivery, and analytics. In terms of process, some network embodiments enable business users (such as advertisers and locations) to create experiences using tools to create and manage structured and unstructured content for customer experiences such as advertising, editorial, social, and video, including content management, digital asset management, e-commerce, customer relationship management, marketing campaign management, marketing resource management, and interactive development environments.

The experiences are heightened by the intelligence solutions that enable businesses to gauge the success of the user experiences. Embodiments of the inventive network comprise the ability to collect key data sources and behavior indicators across all search engines, browsers and activity patterns—specific to user devices. As a result, the vantage point is the entire network, rather than a single search engine, a single user session, or a single browser-type, which is the standard today. The inventive network leads to a full and accurate understanding of consumer behaviors and sentiments. Social analytics provide insight into how consumers engage with companies, and each other, by creating and monitoring social interactions through network data assessment.

In embodiments of the present invention, an on-line experience is accessible to a user by providing a network environment comprising one or more devices that are configured to communicate with the user and, in the case of more than one device, with each other. With many of the embodiments contemplated inventively herein, content sought by the user (e.g., information responsive to a search query) may be influenced by reduced content, supplemental content, or alternative content controlled by the primary server prior to its being directed back to the user. In some cases, that experience can be enhanced by reducing the amount of content otherwise responsive to the user's search query, for example, so as to eliminate undesirably or valueless noise. In other cases, it may be to add information that is relevant to the user based upon what the primary server detects about the location of the user or the particular time and day that the user is “on-line,” or any other metrics about the user, including demographics. Or, in yet other cases, it may comprise substituting less valuable information with more valuable information. At least one of the above, or combinations of all three, are contemplated by embodiments of the present invention to cause the user's network experience to be more meaningful than it otherwise would have been. The combination of software, servers, and information stored on the servers are configured to influence the scope and content of information directed to the user based upon, in some examples, queries and/or solicitations expressed by the user, so as to add value to the users network experience.

Embodiments of the present inventive network environment comprise a repository server or the like configured to dynamically store information and applications that may be segregated into discrete and/or overlapping categories pursuant to one or more metrics of relevance and value to potential users of the network. In some embodiments, the repository server functions as a database of static and dynamic content provided by third parties, such as network customers or members (i.e., destinations) who wish to direct relevant content to users. Businesses or those who wish to influence behavior of others, for example, may utilize the benefits of embodiments of the present invention by uploading content to be shared with network users. So the network provides a beneficial vehicle for directing relevant and meaningful information to users to enhance the user experience.

Embodiments may further comprise a proxy server or the like, for managing the presentation of information and applications to the user, as well as a web server or the like, for caching and presenting such managed information from the repository server to the user. Importantly, the location of repository server, the proxy server, and the web server are not critical to effective network environment experience by the user, although optimization of the network may drive positioning into certain locations both locally and/or remotely. In some embodiments of the present invention, the proxy server and the repository server may be located within the local network to which the user is connected via the client computer (desktop, laptop, tablet, smartphone, PDA, etc.), where a local network server is provided with software to permit communication with the repository server. Indeed, in some embodiments, the proxy server may be housed together with the local network server, and programmed to interface with the repository server. In yet other embodiments, the proxy server and the repository server may be housed together with the local network server; i.e., as a single unit so that everything needed to provide the inventive network contemplated herein is provided in a single device, albeit one that is more complex than where the repository server and the local network server are separate devices. Furthermore, in some embodiments, the network comprises the application of rules programmed into the local network firewall to direct traffic initiated or solicited by the user through the designated proxy server, which itself serves to manage communication between the client, the web server and the repository server.

A wide variety of arrangements and configurations are contemplated for embodiments of the inventive network. In other words, the location of the repository server, the proxy server, and the web server may be selectively placed to optimize the user's experience while benefiting network customers. Moreover, depending upon traffic and location, each server may comprise a single device with sufficient memory and speed to accommodate the traffic therethrough, or multiple devices where traffic is heavier than a single device might effectively handle.

By way of example, in some embodiments, the network environment may comprise an existing local network server, to which a repository server may be added that stores information unique to the network environment and that interfaces with the local network server to enhance the user's experience through a presentation of content, graphics, and options relevant and useful to the user by way of the client, otherwise known as the user's device (e.g., computer, tablet, smart phone). For example, the local network server may comprise an existing complement of gateway, firewall, web server and proxy server that individually and collectively empower a user to communicate with the Internet. In such an embodiment, the network environment comprises software added to the local network server to permit communication with the repository server that may reside locally and/or remotely, including as a virtual server existing in the cloud, as is often colloquially recited. Or, the repository server may be positioned within the local network where circumstances suggest doing so effectively, as alluded to above. Likewise by example, in other embodiments of the present invention, the repository server may be located remotely as a virtual server and the proxy server may be housed discretely within a local network used by the user or may be positioned virtually in the cloud by way of remote location. One of the advantages of embodiments of the present invention is the flexibility afforded by providing an enhanced network experience to a user without limitation of where the proxy server and the repository server reside. Examples of arrangements are shown in the accompanying figures.

In one embodiment, a method of tailoring the relevance of digital information for receipt by users within networks is provided, in which the method comprises, by way of a proxy server associated with a network situated at a particular location, collecting geographical information associated with each of a plurality of network servers that are a part of the single network, where each network server may be accessed by one or more users; assigning a unique identifier to each of the network segments within the network; associating the geographical information with the unique identifier, and selectively transmitting digital information to the user at a particular network server that is relevant to the user based upon the geographical location of the network server, whereby the digital information transmitted has geographic relevance to the user without the need to ask the user for his or her geographic location. In one application, an embodiment of the present invention could be programmed to apply a layer over an existing network (for example one that already exists at a location—e.g., hotel or convention center) for certain requests by users. For example, certain queries would be directed through the inventive network architecture so that those selected queries could be manipulated and some of the content controlled, whereas other queries would simply bypass the system. In alternative applications, an entirely new network embodiment is employed at a location through which all queries are directed, and for which a great deal more services may be added to the user experience. In certain embodiments, a network embodiment may comprise a plurality of zones; for example, a zone established in different places within the location (e.g., hotel—for example, the pool, the casino, the community room, the reception halls, the guests rooms, each zone being programmed and controlled to offer a different experience.

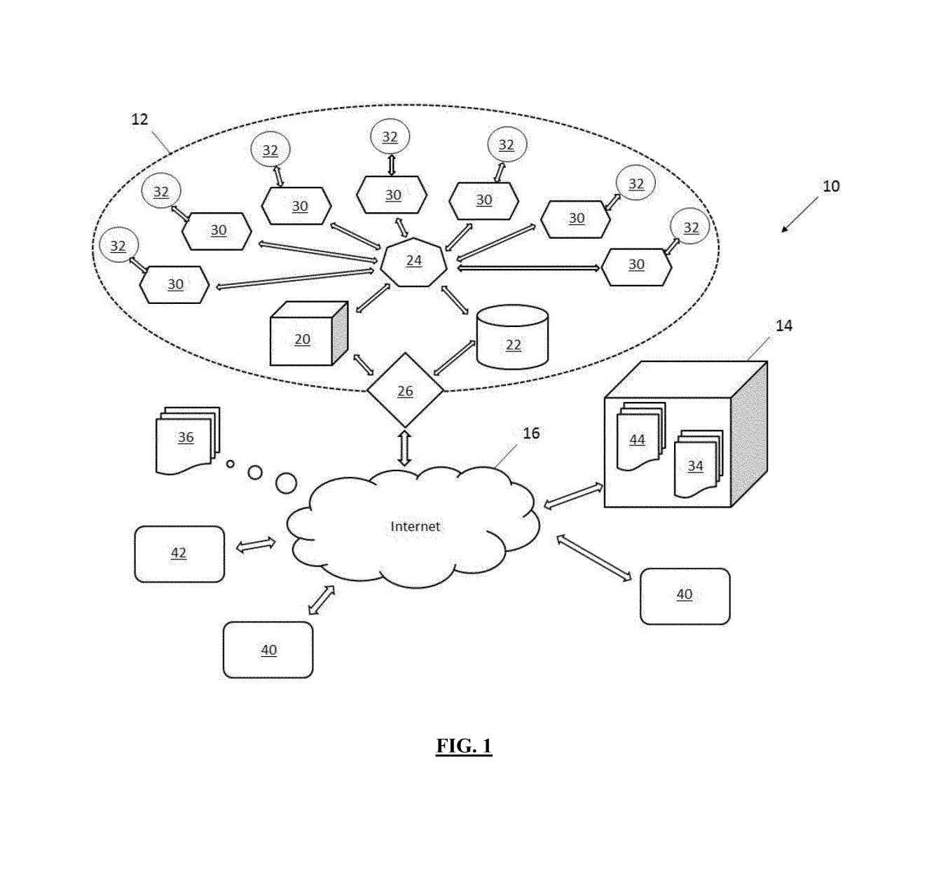

With reference to FIG. 1, one embodiment of the inventive network 10 herein comprises a private local network 12 coupled with a repository server 14 positioned remotely so as to be accessible through the Internet 16. In one example, the private network 12 comprises a web server 20, a proxy server 22, a firewall 24 and a gateway 26, together which function and are programmed to serve a plurality of clients 30 used by a plurality of possible users 32. The users 32 may obtain content 34 that is stored on the repository server 14 or content 36 available elsewhere on the Internet, where repository server content 34 may be provided and controlled by content providers that may comprise network owners/administrators 40 or other content providers 42, such as local advertisers, local and national governments or, indeed, individuals, who may be granted authority to upload content to the repository server 14 to present content to users 32 within the local private network 12 of one system embodiment 10. In certain embodiments, a web-based application 44 is provided, which may be stored itself on the repository server 14, that functions as a content management interface that permits content providers an on-line vehicle to manage the type of content that is delivered to the clients, where the architecture of the local network 12 is programmed and functions to deliver such content to the clients 30 in a controlled manner so as to enhance the experience of the users 32.

The proxy server 22 is preferably programmed to communicate with the repository server 14 to periodically, and on demand as well if so desired, so that relevant content stored on the repository server 14 may be stored on the proxy server 22 for quicker and easier direct access to the user 32 without the need of accessing the internet. In that regard, the relationship between the proxy server 22 and the repository server 14 function to permit the local network 12 to function like a quasi-intranet. The firewall may be programmed with rules that direct any Internet traffic solicited or initiated by a user through the proxy server so as to control and manage the content otherwise directed through the web server and gateway. In that regard, the web server, as directed and/or managed by the proxy server, will have access to information from the repository server for caching on the web server and presentation and accessibility by the user. It is further contemplated that the proxy server and firewall are configured, for example, as described in co-pending U.S. application Ser. No. 12/873,255, filed Aug. 31, 2010, entitled Methods Of Providing Digital Content Tailored To Users Of Private Networks Within A Protected Virtual Environment, incorporated herein in its entirety by reference.

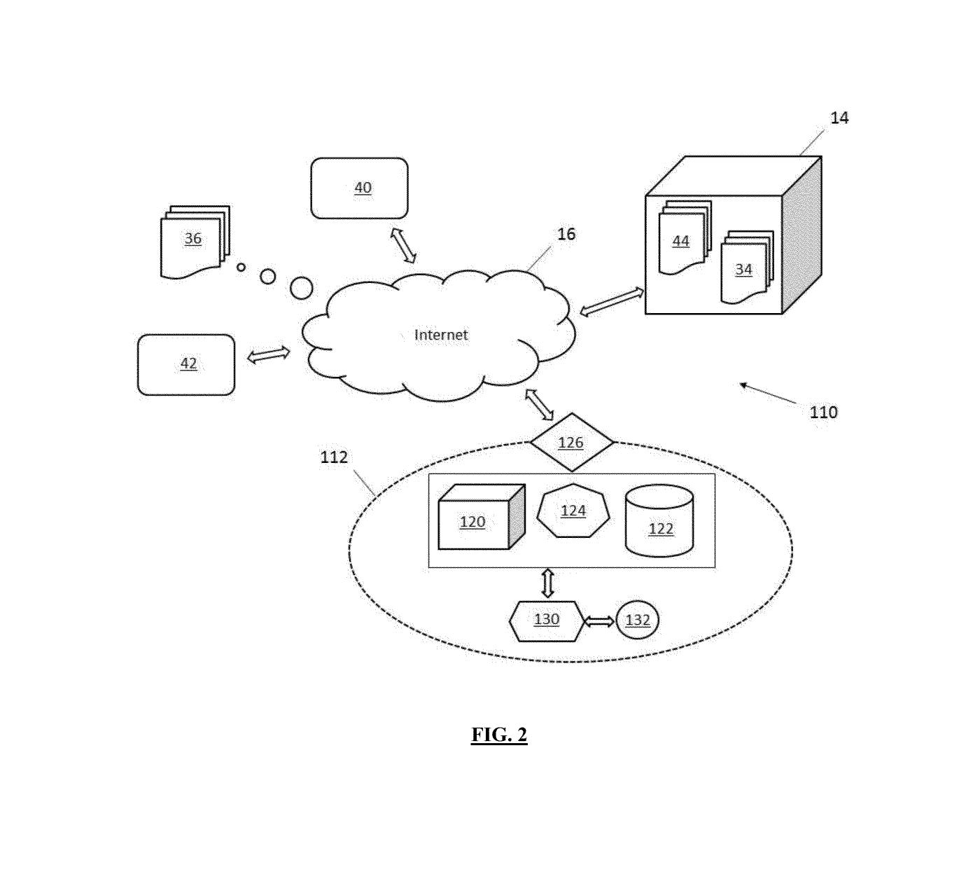

Referring to FIG. 2, one example of an alternative embodiment 110 comprises a more compact private network that may be suitable for more localized user experience. In that regard, embodiment 110 comprises a local network 112 itself comprising essentially, for example, a single black box comprising a web server 120, a proxy server 122, a firewall 124 and a gateway 126, each of which combine to serve a client 130 for use by a user 132. Such an arrangement may permit portability of such a private network because, as with the local network 12 or FIG. 1, the local network 112 permits user access to content 34 on a repository server 14 from network owners 40 and other content providers 42 via the content management interface application 44.

It should be appreciated that in certain embodiments the proxy server may be positioned remote from the users and local network servers; in the cloud, so to speak. The proxy server may be positioned locally to or remotely from the repository server. This arrangement provides the advantage of facilitating implementation of embodiments of the inventive network onto existing infrastructure.

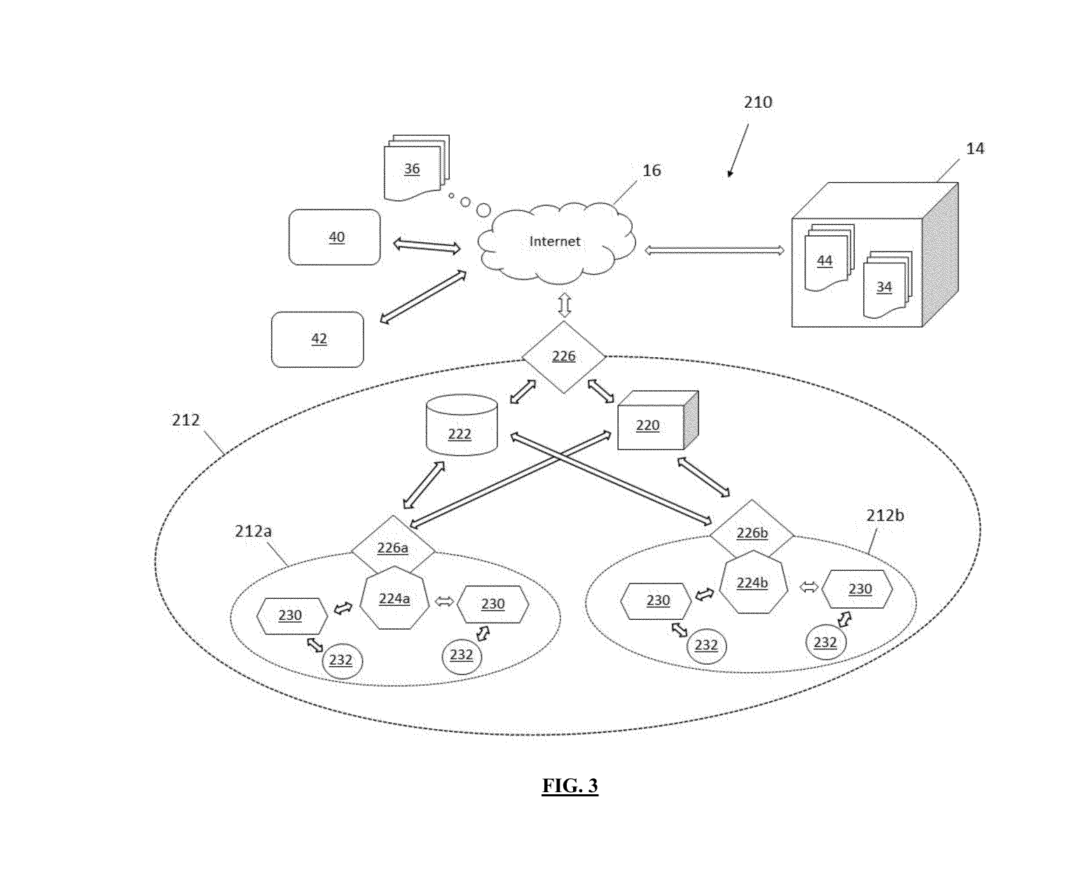

Yet other arrangements are contemplated for the inventive private networks described herein. For example, with reference to FIG. 3, it is possible to vary the user experience within the same local network by creating zones. By contrast, in the embodiment of FIG. 1, each client would present the same experience to the users based upon the particular architecture arrangement. However, with some locations, such as a hotel, with multiple environments, separate zones within the private network could be established that permit a difference experience for each zone. As shown in FIG. 3, local network 212 comprises a plurality of zones 212a and 212b (two shown by example only) each communicating with a web server 220, a proxy server 222 and each comprises a firewall 224a and 224b for exchanging information through gateways 226a and 226b for each zone and gateway 226 as between the private network and the repository server 14 through the Internet 16 for controlled content 34 and other Internet content 36. Within each zone 212a and 212b, the rules established will permit the network to be able to isolate through the identity of the zone which portion of content stored on the repository server 14 and transferred to the proxy server 222 is more appropriate or one zone or the other.

In another example, assume that a potential network customer comprises a large tire store franchise which thousands of stores across a wide geographical area, where the tire store customer desired to direct relevant content to its clientele while they wait in one of the stores for their automobile to be serviced. Assuming that, for one particular locale (e.g., a city), there are 50 tire stores provided with a gateway/firewall device permitting clientele to have wireless access to the Internet, one application of an embodiment of the present invention network experience may be described. In the regard, one embodiment comprises a proxy server stored remotely within the facility of a server host, either within the city or geographically close to the city. The gateway/firewall devices would be configured with a set of rules, including at least one rule that directs user traffic to the proxy server provided to address at least these particular 50 tire stores, if not others as well. In this example, where the larger tire franchise has another 40 tire stores in another locale (e.g., another city), another proxy server could be provided directed to this latter set of tire stores. Or, depending upon the expected amount of traffic and respective distance, a single proxy server may be provided to serve both sets of 50 and 40 tire stores collectively. Such a proxy server is preferably configured to, for example, cache information stored on the repository server that would desirably be directed to the tire store clientele, and updated periodically via communication between the proxy server and the repository server. For example, the proxy server could be programmed to “phone home” so to speak every 15 minutes to see if additional content has been uploaded to the repository server that has relevance to tire store clientele; e.g., updated advertising, etc.

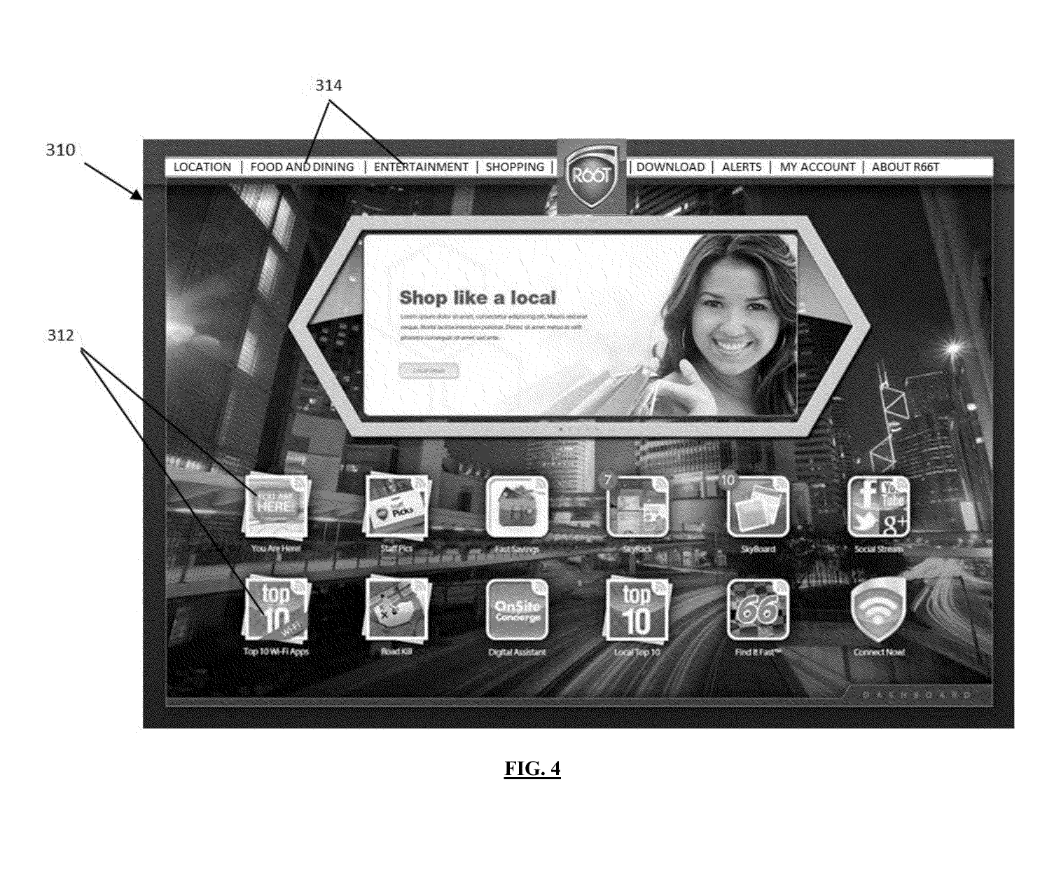

The embodiment described by way of example, further comprises a web server positioned somewhere beneficial to the network customers (including the tire store franchise as well as other third party entities desirous of directing relevant content to the tire store clientele). If desired, a user log-in interface may be provided that is cached on the web server, with for example, confirmation of the user stored on the repository server. A person of ordinary skill in the art should appreciate the variety of configurations and arrangements possible to tailor the network to groups or users and network customers (or members). The web server, for example, could be programmed to present store content and applications preferably relevant to the tire store client (as well as other content and applications relevant to other consumers), along with a dashboard of icons and menu items, and other functionality designed to enhance the experience of the tire store clientele. An example of a dashboard 310 can be seen in FIG. 4, with the R66T™ trademark reflecting at least one purveyor of the inventive network embodiments described herein, with icons 312 and menu items 314 selectively displayed. The dashboard could be created, manipulated and modified as desired and updated periodically by the network owner for presentation by the web server to the client for viewing and interface with the user.

As referred to above, the repository server stores unique content developed to enhance a user's experience when they enter the inventive network. For example, the repository server may store virtual advertising space that a network customer or member may employ to promote a business or cause to a network user. An example of one such application is disclosed in co-pending U.S. Ser. No. 13/562,241 filed on Jul. 30, 2012, and entitled System and Method for Managing An Advertising Marketplace, incorporated herein in its entirety by reference. In another example, the repository server may store content about destinations within the geographical area of the user based upon the location derived, for example, from information derived from the firewall and/or gateway, through which the user has accessed the network or by the access point within a sub-network or private network. It should be noted that the geographical correlation may be determined by other vehicles as well, including for example, global positioning of the user or the user's computer.

It is contemplated that network customers that have become members of the network can upload relevant content about their business or cause such that such content can be accessed by a user who, for example, has solicited such category of information via a query or applet. By assessing the geographical area of the user, as provided passively by the user's gateway or firewall, the primary server may function to filter through to the user on those destinations that are both responsive to the user's solicitation or query and within the user's local geography. As such, less noise is presented to the user and only more relevant information is provided. In some embodiments, the network is configured to steer relevant content by a particular location in a hotel (i.e. push drink advertising to guests at the pool that would be different than content set elsewhere). In other embodiments, the network may be configured to direct content that is time relevant: a time sensitive event: for example, “come into our bar from 9 pm-12 pm for drink coupons”. In yet other embodiments, the network may be configured to present content that is relevant by demographic information, for example, gender, income, or whatever other demographic information may be available to enhance the user's experience.

Other information contemplated for storage on the primary server for access to a user is a perpetual dynamic dashboard that presents itself in an overlay format upon the user's computer display. The dashboard may comprise creative and attractive graphics that include one or more icons each hyperlinked to a prescribed sub-category of information stored on the primary server or accessible through a network to which the primary server is associated or the Internet. With such an environment, a user is presented a unique set of options tailored to the user in the form of information or applets of interest and relevance to the user. The dashboard preferably includes menu items presented in, for example, pull-down format or other arrangement or configuration, for carrying out useful functionality adapted to enhance the value of the information and applets provided. It is contemplated that a vehicle for establishing a user account, for example, may be provided either through the dashboard, or other interface communicated by—for example—direction of the proxy server through the web server to the user. The dashboard, although originating on the repository server, is preferably cached on the web server so that a user may experience the dashboard more seamlessly, depending upon where the various servers are positioned.

One feature contemplated for use with at least some embodiments of the present invention entails utilizing existing advertising space on third party web pages to present more relevant advertising by, for example, advertising overlay or ad replacement. In that regard, part of the ability to enhance a user's network experience is to provide more relevant advertising by substituting on pre-configured content conveyed to the user information about business or causes that are more likely to be of interest to the user than the advertising otherwise associated with the pre-configured content. So, for example, when presenting content responsive to a user solicitation or query, where the content is pre-configured to include non-member advertising that has little or no value to the user, the present network comprises the ability to present more relevant advertising that is provided by network members to the user in a manner that is not intrusive or disruptive.

Traditionally, prior approaches have included rewriting the content being routed to the user's machine by injecting an advertising bar or banner into the top or bottom of every page loaded into a user's browser. It is often done so by editing the contents of the HTML code as it travels through the existing network and before it reaches the end user. In one conventional pathway sequence, 1) an end user enters the URL of a desired web page into their browser; 2) the network gateway receives the request, and sends it out to the open Internet; 3) the proper resources are found on the Internet and sent back to the network gateway; and 4) the network gateway receives resources from the Internet and sends them back to the end user. When the network traffic reaches the network gateway, the gateway may be programmed to hand off the traffic to a proxy, which can observe and alter the content of that traffic if so desired. In the case of injecting advertising, the proxy will rewrite the HTML code of the web page and add a banner to the top or bottom of the page, pushing the rest of the page contents downward or upward, respectively, in the process. Research has shown that end users do not respond well to this method of advertising; and networks that operate in this way receive many complaints.

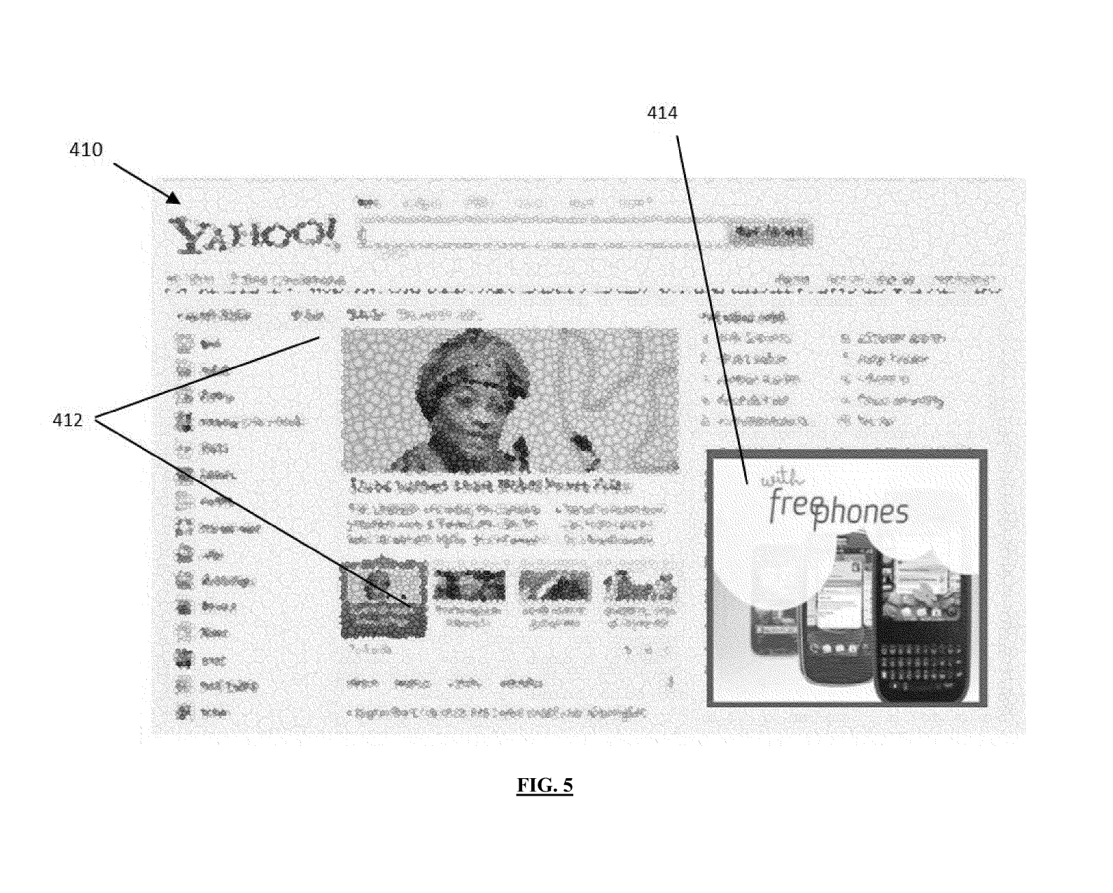

Some embodiments of the present invention improve upon this by employing firmware that presents a more seamless environment to the user. In that regard, the firmware is programmed to observe certain features of the existing webpage, including the size of the advertising within the webpage. For example, referring to FIG. 5, it may be appreciated that a particular web page 410 comprises general content 412 (not relevant here) as well as an existing 300×250 advertisement 414 on the page.

In another embodiment, the firmware may be programmed to observe the top level elements on the page and inject content that will consistently appear over top those top level elements. In another example, the firmware may be configured to identify some location on the page, say for example, the top most left corner of a page in order to periodically provide messages—such as emergency messages—to the user, and guaranteeing that such messages appear over such page content at that spot.

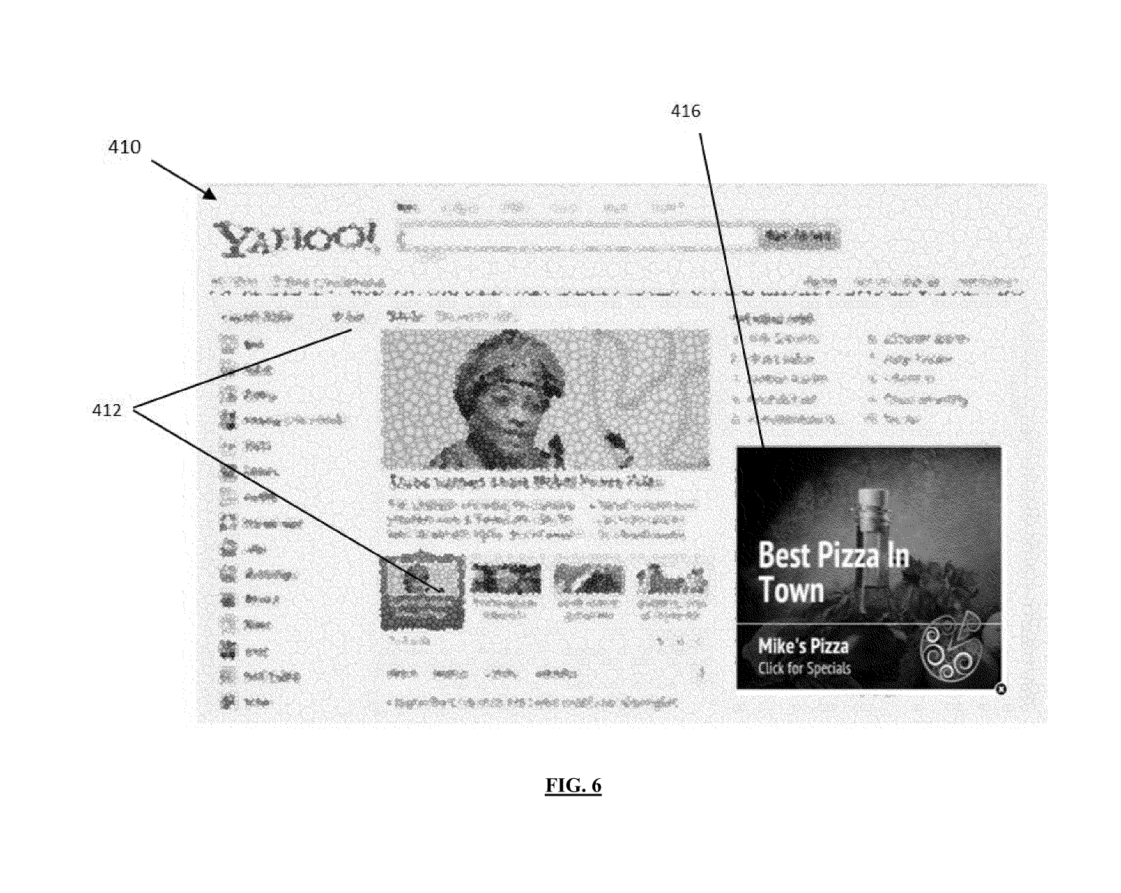

The inventive network hardware is programmed to identify available advertising space on a page, observe its size, and then overlay another advertisement from a database of available advertising inventory stored on the network. By overlaying advertising selected from a controlled inventory of advertising, the inventive network is beneficially promoting the business or cause of the customers of the network without inconveniencing the end user or drawing attention to the fact that the page contents are being altered in display. So for the example of FIG. 5, the resulting overlay advertisement 416 might appear as shown in FIG. 6.

In certain embodiments of the present invention, rather than injecting a full banner with advertising already in place when a web page passes through the network hardware, code is injected into the page in which the code causes the client's browser to scan through the page contents to identify whether an advertisement exists, what its size is, and whether a compatibly-sized ad exists in inventory, and if so, overlay the ad in inventory on top of the existing ad on the page. Preferably, the hardware is programmed such that this sequence of events occurs sufficiently quickly so as to appear seamless to the end user.

It is also contemplated that certain web pages are formatted such that they do not occupy the entire display of a client monitor, leaving untapped and unused space available for content placement. Often such dead space occurs on either side of the web page within the viewable monitor. The inventive networks are programmed in certain embodiments to detect when such dead space exists and to fill it with content relevant to the user.

In one embodiment, the process may commence once the web page content reaches the network gateway from the Internet. Once the content reaches the network gateway, the content is handed off to the proxy server, which will assess the content and decide whether it is modifiable. If it decides that the content should be modified, it looks through the page HTML code and identifies the appropriate place to inject our code.

For example, in a somewhat simplified example, the existing code may look like this:

```
<html>
<head>
    <style>
        body { margin: 0; padding: 0; }
    </style>
</head>
<body>
    This is a web page.
</body>
</html>
```

When the proxy server receives this HTML code, the place to inject the new code (or command) is identified. In one example of code injection placement, the new code is injected inside the head of the HTML document, where the modified version of the HTML code is then sent to the client, which might see, by example only, HTML code that looks similar to the following:

```
<html>
<head>
      <script type=“text/javascript”
src=“http://{SYSTEM_DOMAIN}/r66t_static/js/overlay.js”></script>
    <style>
        body { margin: 0; padding: 0; }
    </style>
</head>
<body>
    This is a web page.
</body>
</html>
```

In one embodiment, the injected code comprises client-side scripting, which itself comprises a separate set of code that instructs the ad overlay functionality. The script may commence operation after the web page (with the injected code) has been loaded in the end user's browser, which then obtains the client-side script from the inventive network's web service. Once the web page has loaded, a conversation is initiated between the client-side script and the web service configured to determine the most relevant content for the user and the methods most appropriate for inserting such content. Relevancy is determined based upon a plurality of collected user and client static and dynamic attributes, for example, location of the client, the user's web history, time of day, etc.

In one example, if an advertisement is identified on the existing web page, the client-side scripting functions, in some embodiments, to place a new script on the page that loads an advertisement from a repository of available advertisements stored on the network. The end user's browser then receives the new advertisement, which may be placed directly on top of the original advertisement. In some embodiments, the user is given the ability to close the advertisement, revealing the original ad underneath it. In other embodiments, the original advertisement is scraped away and replaced with an advertisement from the advertisement inventory. In some embodiments, the client-side scripting executes inside of the end user's browser, as opposed to server-side languages that execute code before the content reaches the end user. At least this embodiment of ad overlay methodology described here takes advantage of this client-side ability to inspect elements of a web page once the page has loaded and is displayed to the end user.

A person of ordinary skill in the art should appreciate that algorithms may be employed to accommodate varying ad scenarios utilized throughout the Internet. Each of these algorithms identifies a specific kind of ad that exists on the Internet, and permits embodiments of the present inventive network to gain widespread ad coverage without creating specific scenarios for every individual web page online. For instance, one algorithm that identifies an ad on yahoo.com may also work to identify an ad on cnn.com, even though they are separate web pages. In a specific example, code may be written to specifically identify a scenario where an embed tag resides on the page with an IAB standard ad size (ex: 300×250, 728×90), or where an embed tag has a parent object tag with an IAB standard ad size. A single algorithm might therefore successfully identify a wide selection of ads across the Internet in a very generic way, allowing wide-spread coverage to be gained without programming site-specific scenarios.

It is contemplated that any type of image (e.g., photos), video, or other media may be selectively applied in overlay form on top of third party content using the methodology outlined above, or using an alternative methodology that selectively discerns desired locations on the third party content for controlled placement of such media in one or more locations. The media may be personal to the user and stored on the user's hard drive or remote server hosted by a fourth party such as, by example only, Flicker, Facebook, etc. By overlaying media, including advertising media, on top of third party content, the experience is further enhanced to the user's benefit.

Another feature contemplated for embodiments of the present invention is the ability to direct information dynamically to users quickly in both a targeted and/or wide distribution, where so desired. In one such embodiment, targeted dynamic content may be directed to one or more users within a specific locale isolated by way of trilateration using at least three wireless transceivers (or radios) associated with network systems employing some or all of the technology described herein. By situating transceivers at select locations, stationary or roaming users may receive dynamic content provided by embodiments herein in which the content is limited in its distribution to those users within the area defined by the select locations. In one example, three transceivers are positioned at the three points of a two-dimensional triangular geographic region (i.e, floorspace within a retain outlet) that define a location within an aisle or department within the retailer's store. In another embodiment, the locale may be defined by users within range of a single transceiver, where less granular location may suffice. Any number of possible arrangements are contemplated that permit a network operator to target more or less specific geographic areas/locales.

In one application, the retailer may wish to push content dynamically about the products presented within the aisle or department to those users within or passing through the specific location. The type of content may include discount information about the products, comparative information with regard to competing products, upcoming deals, etc. The content may be stored or uploaded on the repository server or elsewhere on the network, where such content may be updated continuously or periodically by, for example, the retailer or agent of the retailer.

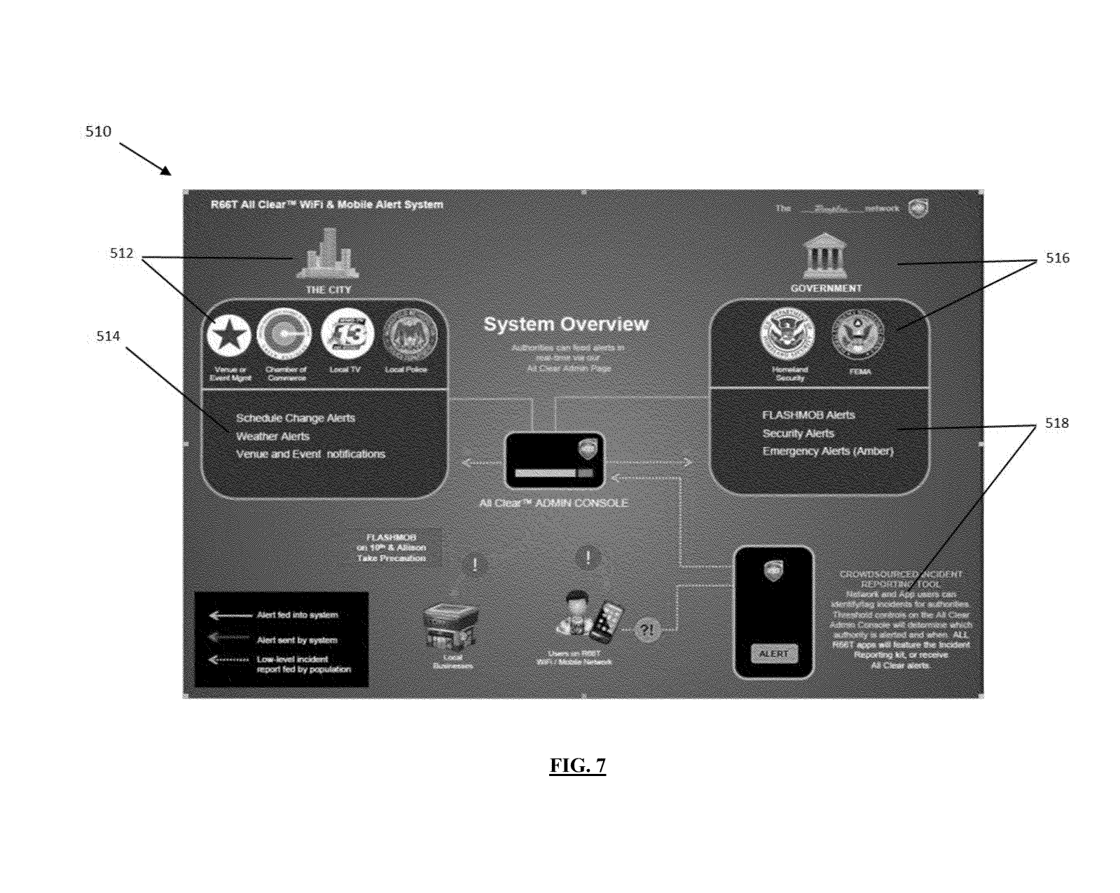

In another embodiment, the proxy servers and web servers are programmed to push dynamic content to a wide distribution—for example, emergency notifications stored on the repository server in emergency situations. For example, a governmental body may be provided with the necessary hardware and software complementary with embodiments of the present inventive networks so that the governmental body may upload to the repository server alerts of general importance and interest to users who have an account with the network and/or who are poised to receive information sent by the network. In such an arrangement, the proxy servers, for example, would be programmed to direct the local network servers to accept emergency alerts from the network's web server that come in from the repository server. An illustrative presentation of one embodiment of such an “all-clear” page 510 of content is shown in FIG. 7, comprising by way of example only city information 512 containing relevant information 514 about city services or local alerts as well as federal government information 516 containing relevant information 518 about national alerts and news.

Embodiments employing the all-clear feature can be used in non-emergency circumstances as well, including during complex events that span multiple days and utilize several venues (like Super Bowl Week or racing events). Such embodiments naturally unify event participants via promotions, connectivity and companion mobile tools. Such embodiments takes advantage of the aggregation of both business and travelers under one system to then connect them both to the city and local government. This allows for another layer of communication that can be used by authorities to enhance the visitors experience.

The network feature could also be used to communicate with large amounts of partially-disoriented travelers and participants during events where the arrival process is unfamiliar, or where changes in venue and weather have a disruptive affect on large numbers of people interacting in one location. Unlike events that span a few days, single day events have the potential to be more concentrated and confusing if there is a lack of direct communication with participants. Embodiments of the present invention encourage participants and businesses to unite via such network embodiments provided at an event in order to take advantage of deals and participating programs.

Importantly, the all-clear feature may be used to push dynamic content to users in a specific location within a venue using the trilateration arrangement discussed above. For example, a retailer adopting one or more features of the inventions described herein, may wish to push content dynamically to customers within certain aisles, or within certain departments of the retailer location. In one situation, the retailer may have a special discount established for certain goods located within a particular department or aisle, and desires to provide information about that discount to customers within that aisle or department. The value of the discount is enhanced significantly with such an application.

It is also contemplated that the proxy servers, web servers and repository servers, can be provided with instructions and firmware capable of pushing content through to a user during the user's use of email or IM or social networking, for example, to enhance the experience. Certainly it is contemplated that content may be provided, in one of numerous ways such as those presented above, to a user during the user's social networking For example, the advertising overlay feature may be applied to a Facebook user during their communicating with friends or posting of information.

By way of example, advantageous features of certain embodiments of the present invention may be appreciated by way of describing one exemplary methodology of operating a particular private network where the network owner or content provider can maintain a great deal of control over the client content and user experience. In that regard, one method of managing content on a network and delivering at least a portion of such content to network clients based upon the relevance of such content to client users may comprise collecting content from a plurality of content providers through a content provider user interface, such as the web application described above. Such a web application could be stored and controlled on the repository server. The method could further comprise storing such content provider content within the network for later retrieval, which may also be stored in the repository server. Further steps include collecting static and dynamic user and client attributes, including behavioral history, from those users and clients that are part of the network, with collection being performed by recording of browser history, human assessment, and/or the information processed by the proxy server, and then storing such user and client attributes within, for example, the repository server.

The methodology preferably further comprises using the proxy server to proxy the web traffic—i.e., the loop of requests and responses—of users and clients on the network during at least one web session; deciding whether to modify the web traffic, and if so deciding, then to modify the web traffic to include additional client-side code, and delivering the modified web traffic to the client, all preferably done by the proxy server. The proxying step may comprise intercepting the web traffic. This match-making functionality enhances the user experience to the benefit of both the network owner (or content provider) and the user by matching user/client attributes with content. Importantly, those attributes are not merely reflective of a user's continued use of a single site, but rather across all sites visited, over all periods of selected time and, indeed, across multiple users. Indeed, client behavioral history may be enhanced by multiple users employing the same client system within a private network. The content match-making is more meaningful because it is not limited to merely matching content to a particular site being visited in real-time by a user, but rather by the behavioral history of the user and the client system.

The methodology further comprises permitting the client-side code to be executed by the client browser; initiating a conversation between the client-side code and a web service to determine the most relevant content for the user, thereby matching relevant content on the network with a particular user based upon the user and/or client attributes; and presenting via for example the client browser such relevant content to the user throughout the web session regardless of the site being visited by the user or client. With this example of an application of the inventive private networks, a network owner maintains a tremendous amount of control over the network, permitting the owner to tailor and manage client content to levels and ways not undertaken before.

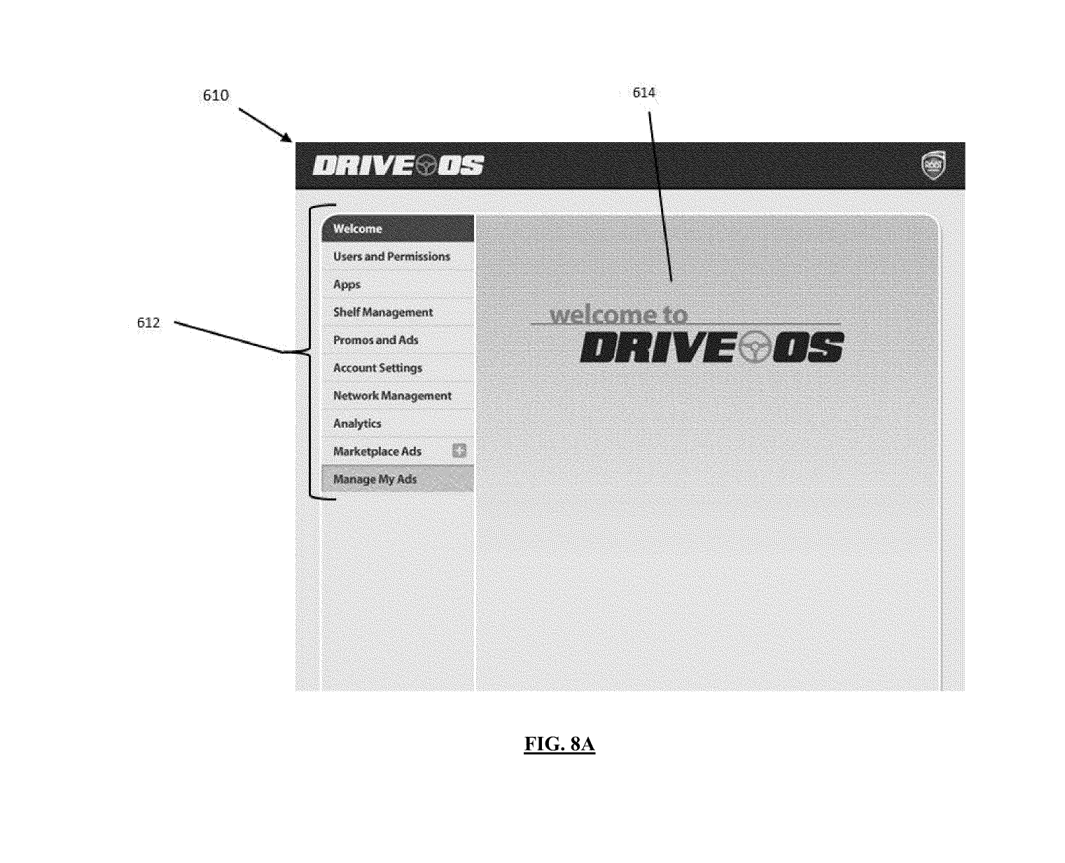

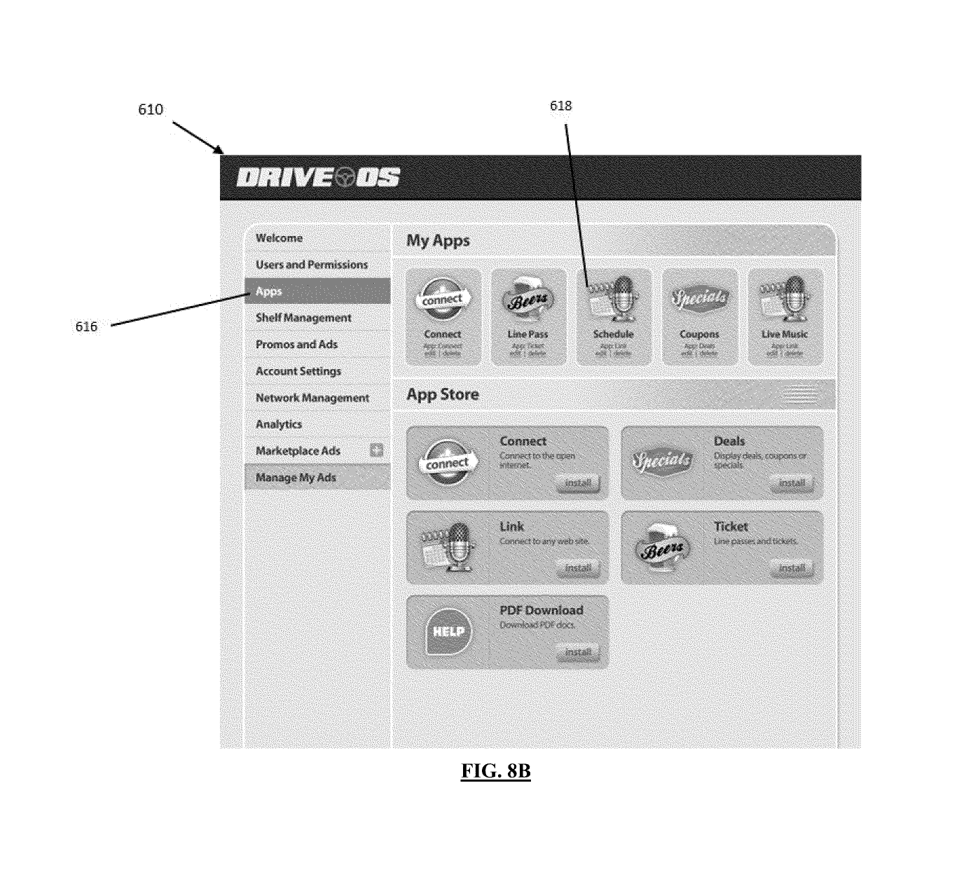

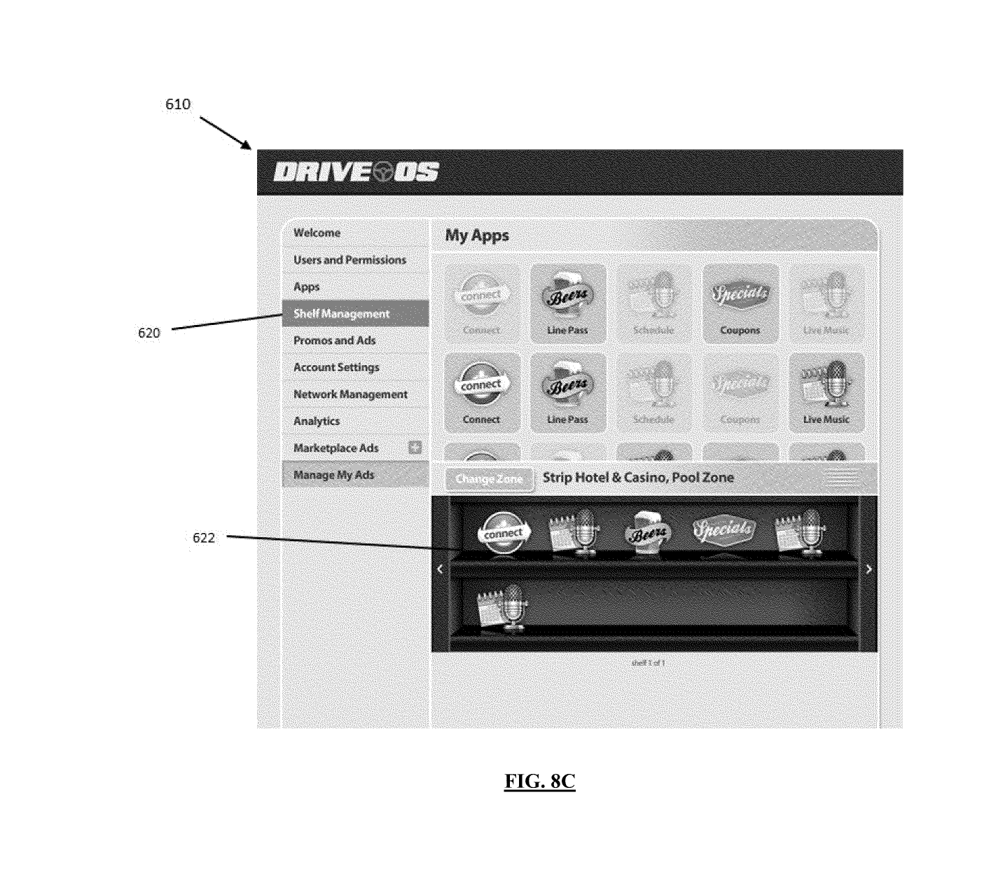

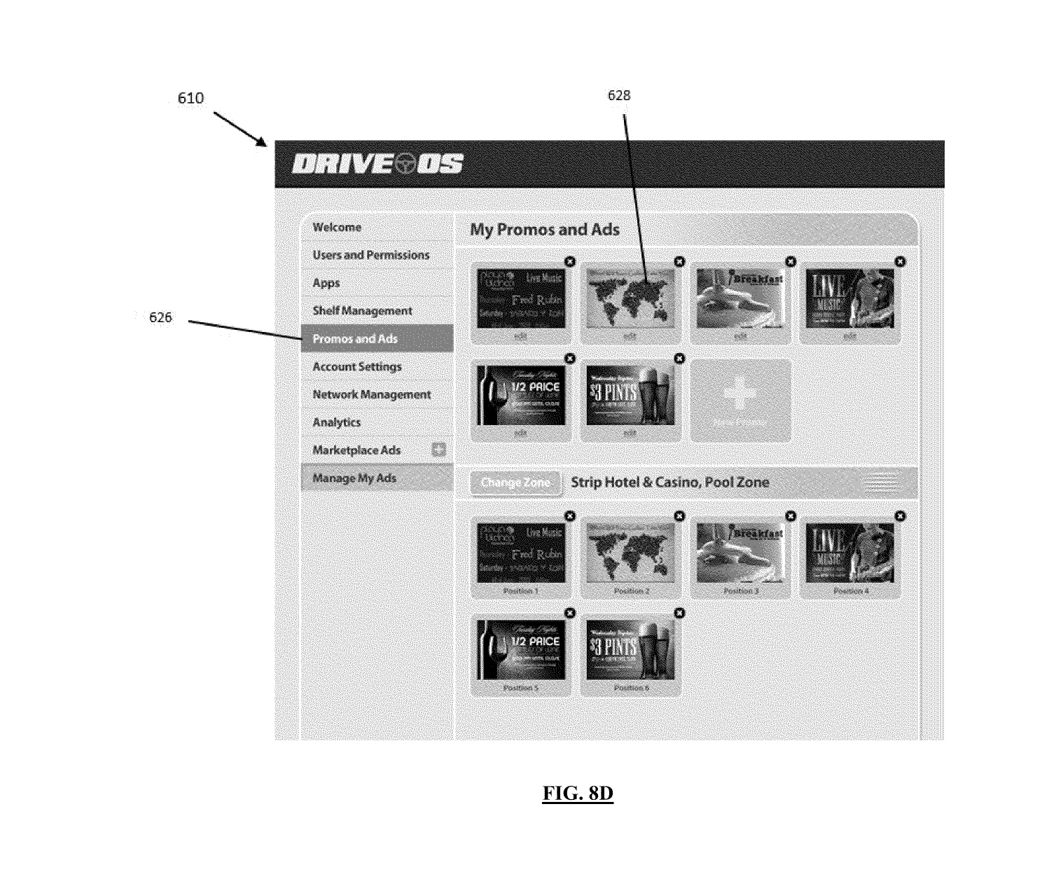

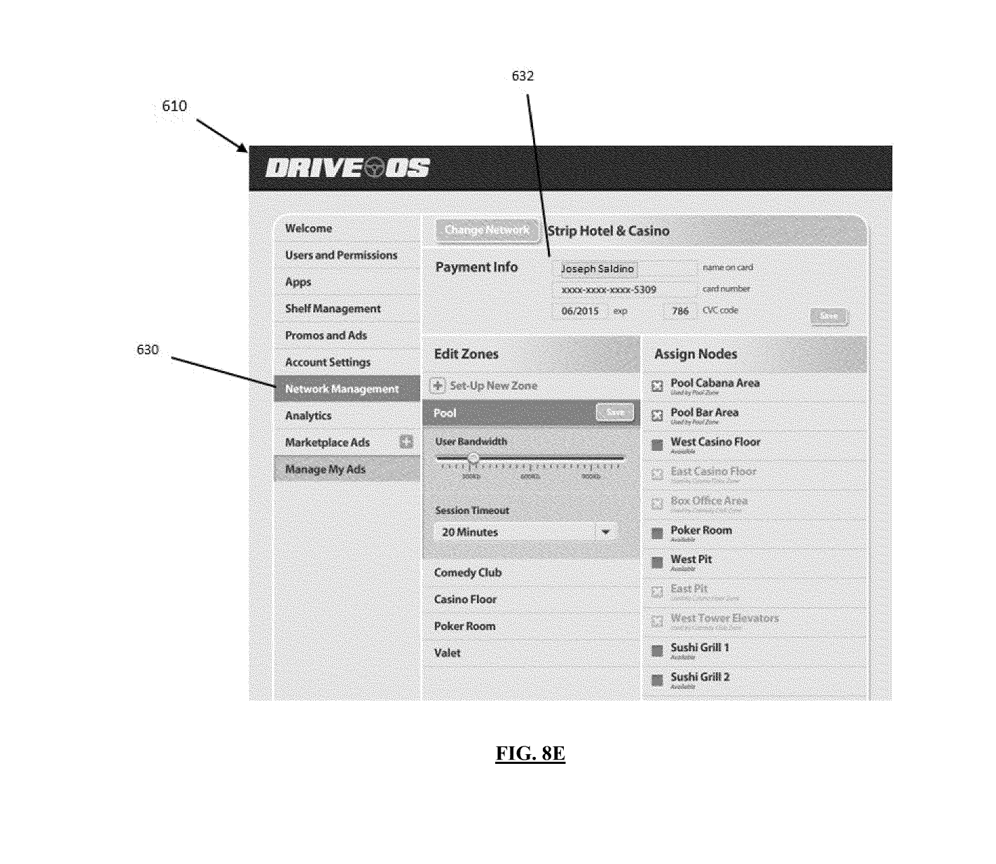

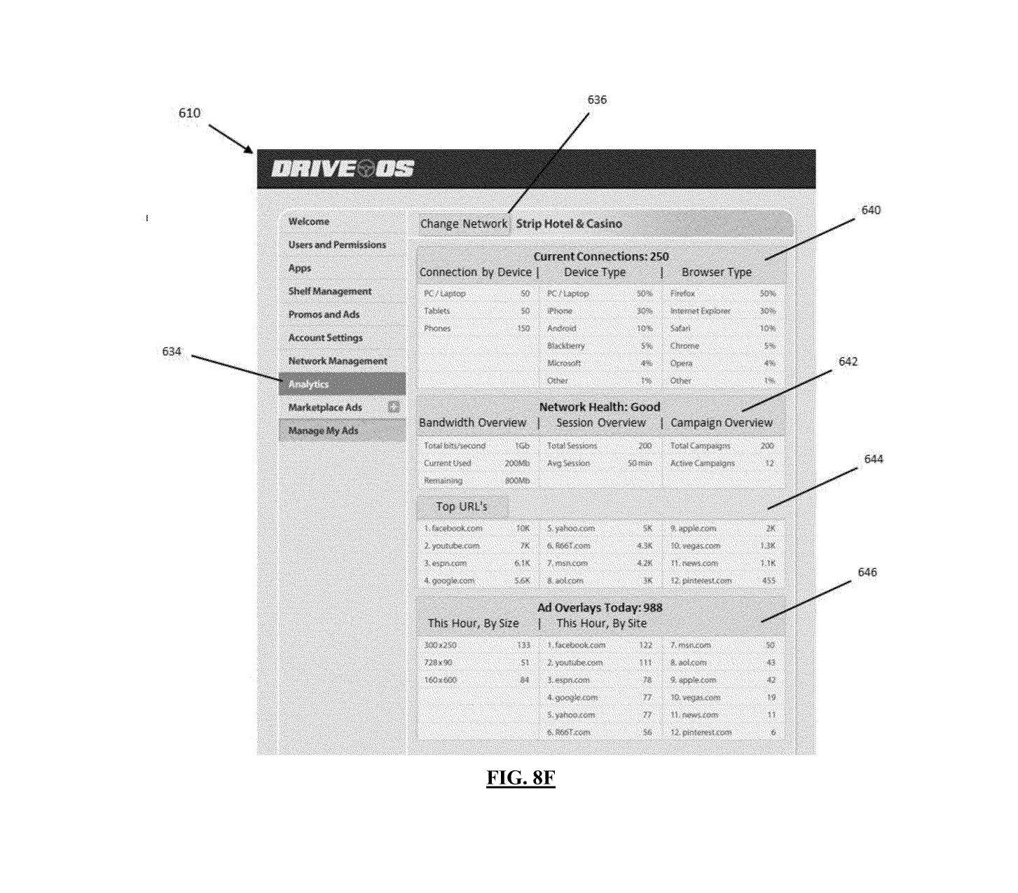

The collecting of content comprises employing the web application provided in certain embodiments of the present invention to add, modify, remove, update and generally manage content for presentation to clients within the network. The content may include advertisements, announcements, alerts or any other information that may be of relevance to the network users. In one embodiment, the content providing application comprises an interface accessible from the repository server through the internet that can take one of numerous possible forms, and which presents an array of menu items and metrics that enhance control over network content by the owner of the network or other content provider. For example, with reference to FIG. 8A, one example of a web-based management interface 610 may be appreciated. In this example, the interface 610 comprises a menu of management tools, and a portion 614 dedicated to providing information relating to a selected tool. One management tool may comprise Apps 616, which may comprises a plurality of applications 618, as shown in FIG. 8B, as well as an opportunity to acquire additional applications.

Referring to FIGS. 8C through 8F, other management tools may be appreciated that may be provided in examples of certain embodiments herein. For example, FIG. 8C illustrates a Shelf Management tool 620 that permits the stacking of icons and other types of links, including those for applications, onto a shelf 622 for ease of visualization and management. FIG. 8D illustrates a Promos and Ads tool 626 for the display of a plurality of advertisements and promotions 628, including the ability to assign certain ads and promotions to specific networks (for those network owners that maintain and manage a plurality of private networks) and/or for specific zones with a particular network. FIG. 8E reflects a Network Management tool 630 that comprises a variety of controllable and measurable metrics and variables 632 for maximizing the distribution and presentation of content with a designated network or within zones within a network, including assigning nodes. FIG. 8F presents one example of an Analytics tool 634 that comprises in one embodiment a link 636 for selecting a particular network, as well as the presentation of dynamic updated information about, for example, the current number of connections 640, the health of the network 642, which itself may comprise a bandwidth overview, a session overview, and a campaign overview, amongst others, a list 644 of the most-used URL's for some particular time period and the number of ad overlays 646 by time period. Other metrics and variables are contemplated as well to maximize and optimize the management of information by a content provider to a private network, but FIGS. 8A thru 8F reflect some examples.

The collecting of user and client attributes comprises both dynamic and static attributes, such as a network identifier and/or network zone identifier, which may be selectively or randomly assigned to the network and/or zones within a network, so that the system recognizes which network or zone therein is at issue in assessing which content to push or provide. Such collection further comprises the browsing history of the user, the client system, the zone and even the network, as well as queries, session information and trilateration, among other attributes. Some of those attributes may be visible or accessible through the web-based content management application 610 described above.

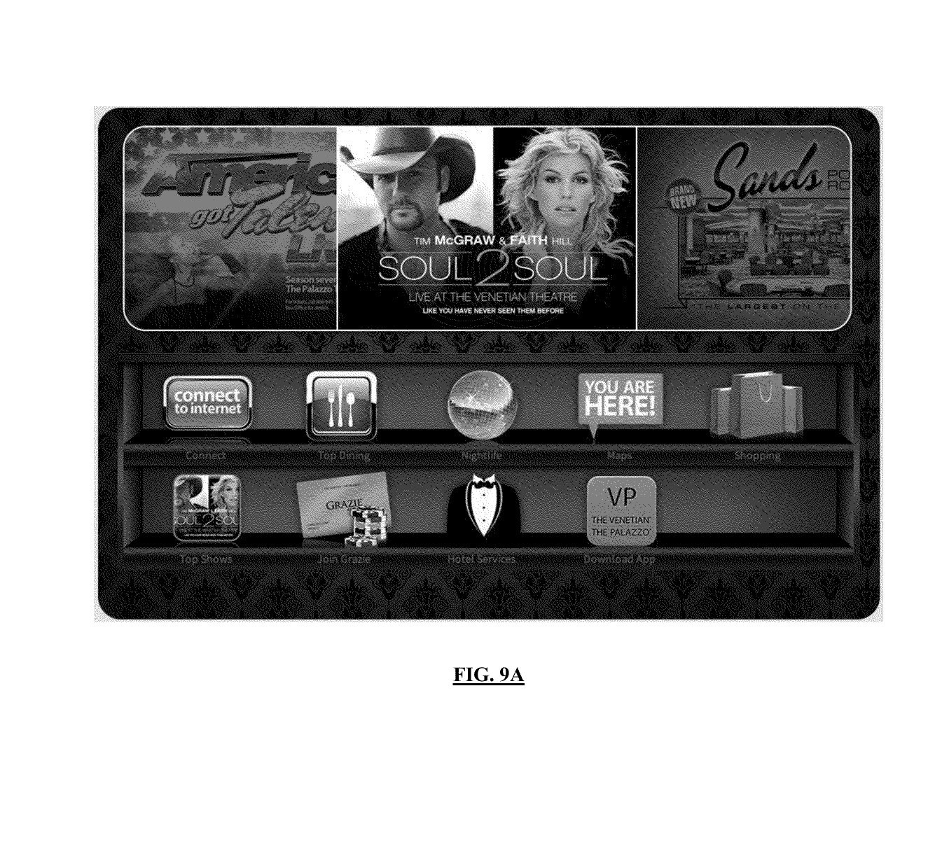

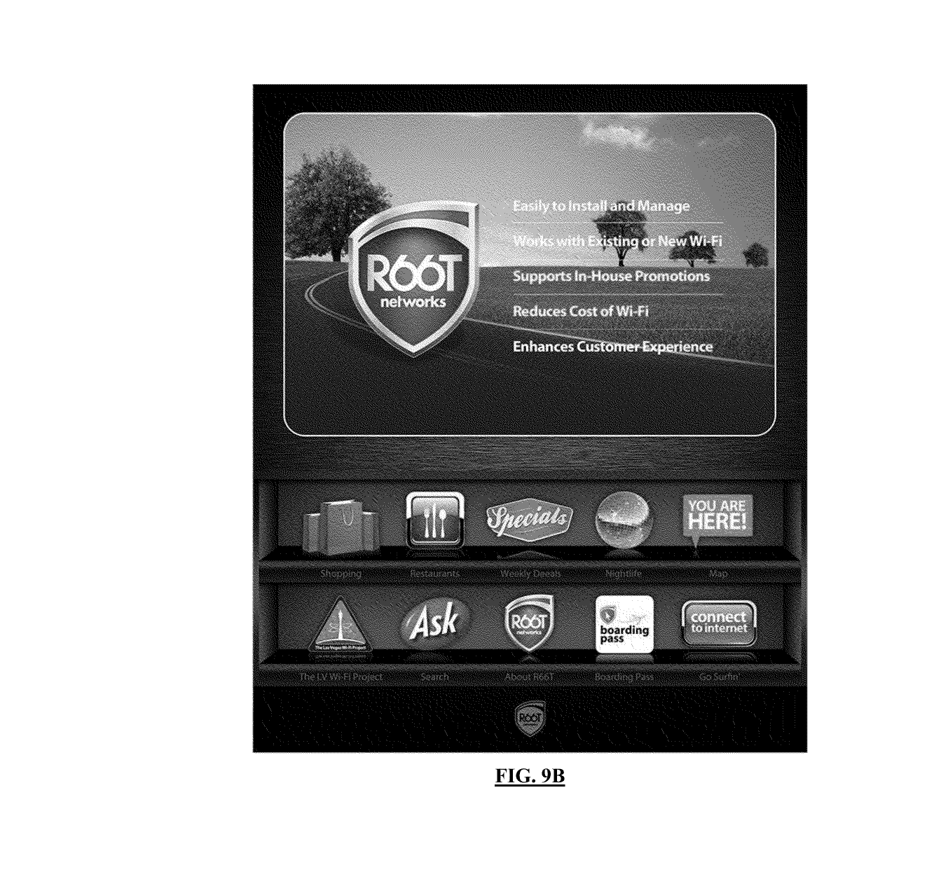

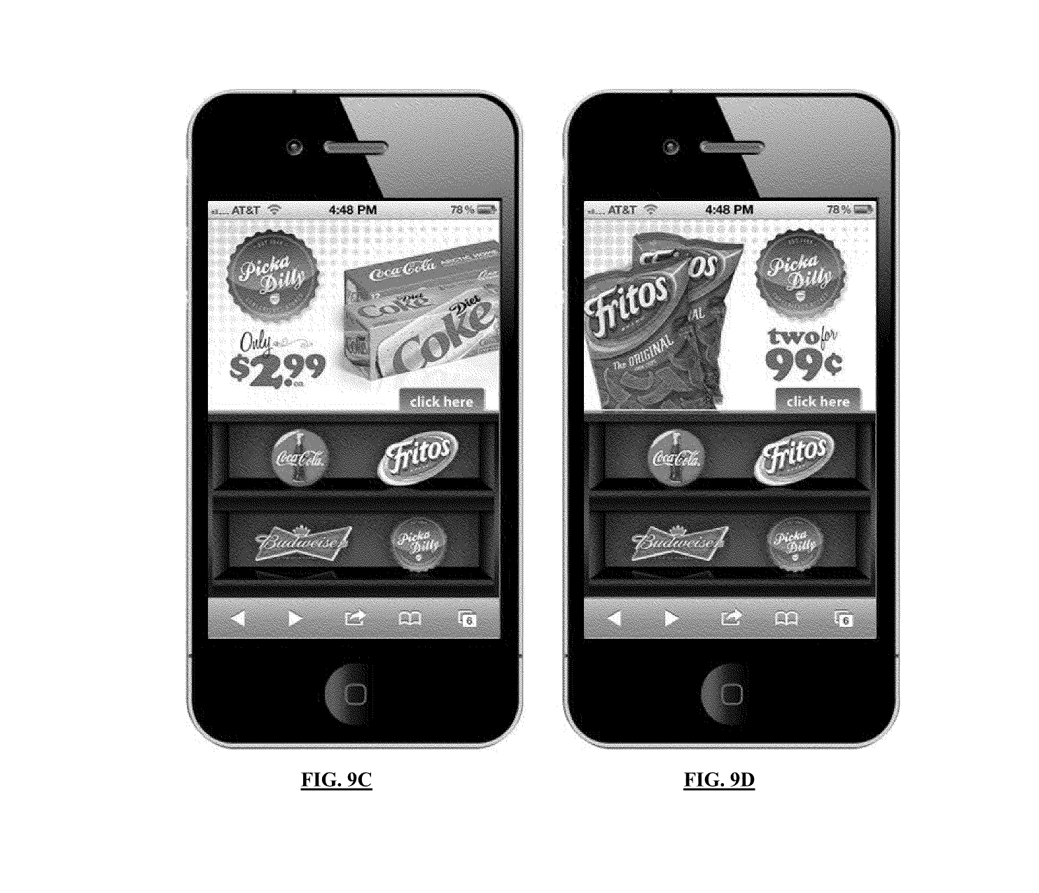

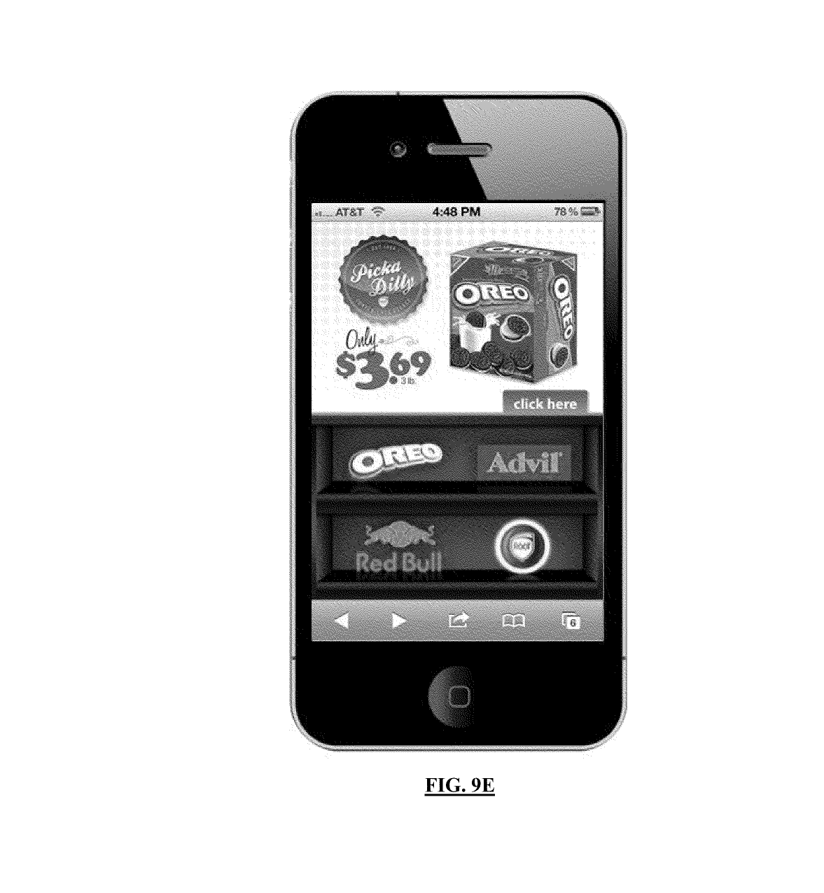

The presentation of content may be in the form of a dashboard and/or shelf configuration, either of which comprise a vehicle for presenting icons, links and thumbnails reflective of relevant content. An example of a shelf is shown in FIG. 8C. The presentation may further comprise ad overlay, and all clear page, a dynamic banner, a moving icon that selectively appears and disappears and other content injection formats that are aesthetic and informative, yet functional and enjoyable. Other contemplated features include tailoring the presentation of content to fit the particular client device employed, whether it is a desktop, laptop, tablet, smart phone, etc. The look and feel may be configured differently while presenting the same or essentially the same relevant content because the system is mindful of the type of client system employed within the private network. For example, FIGS. 9A and 9B illustrate embodiments of a shelf presentation, with FIG. 9A showing a possible shelf configuration for a tablet and FIG. 9B showing a possible shelf configuration for a desktop.

One of numerous possible shelf configurations are also possible for a smart phone, such as that shown in FIGS. 9C through 9E. As with the other configurations, clicking on an icon on the shelf may link to information relevant to that icon, for example, a special being offered by a content provider such as an advertiser, or a network owner sponsor. Certain embodiments of the present invention further comprise scrolling shelves whereby a user may literally scroll the display in a manner to reveal additional shelves with yet additional icons stored on the shelves, as may be appreciated by comparing FIG. 9C with FIG. 9E.

As may be appreciated by the present disclosure, numerous embodiments of private networks are possible that permit a great deal of content management control over the network while providing enhanced experiences for users of such networks. The networks may comprise small and large networks, and zones and nodes within networks. The physical location of the components of the network systems may be varied depending upon desired outcomes by the network owner or manager and may reflect portable networks, single location networks, and multiple location networks. The scope of the invention presented herein is not measured by the few examples presented, but rather by the claims set forth below.

What is claimed is:

1. A method of managing content on a private network and delivering at least a portion of such content to network clients based upon the relevance of such content to client users, the method comprising:
providing a repository server configured to receive content from one or more content providers through a content management user interface, and storing such content on the repository server for managed distribution to network clients;
collecting and storing on the repository server both static and dynamic user and client attributes, including behavioral history of users and clients, from the web traffic established by network users and clients during a plurality of web sessions, where the collecting of such attributes takes place throughout the entire web session and is not limited to monitoring of web traffic to a single website or to a single category of websites;
providing a proxy server configured to proxy the web traffic of a network user and client during at least one web session and deciding whether to modify the web traffic, where the proxy server is further configured to modify the web traffic to include additional client-side code if a decision has been made to modify the web traffic, and then to deliver the modified web traffic to the client so that the client-side code may be executed so as to initiate a conversation between the client-side code and a web service configured to determine the most relevant content for the user, thereby matching relevant content on the network with a particular user based upon the user and/or client attributes; and
presenting such relevant content to the user at least at one point throughout the web session regardless of the site being visited by the user or client at the time such relevant content is presented

2. The method of claim 1 wherein proxying comprising intercepting the web traffic.

3. A method of managing content on a private network, the method comprising:
collecting content from a plurality of content providers through a content provider user interface;
storing such content provider content within the network for later retrieval;
collecting static and dynamic user and client attributes, including behavioral history, from those users and clients that are part of the network;
storing such user and client attributes;
proxying the web traffic of users and clients on the network during at least one web session;
deciding whether to modify the web traffic;
modifying the web traffic to include additional client-side code if the decision is made to do so;
delivering the modified web traffic to the client;
permitting the client-side code to be executed;
initiating a conversation between the client-side code and a web service to determine the most relevant content for the user, thereby matching relevant content on the network with a particular user based upon the user and/or client attributes; and
presenting such relevant content to the user throughout the web session regardless of the site being visited by the user or client.

4. A private network configured to deliver at least a portion of such content to network clients based upon the relevance of such content to client users, the network comprising:
a repository server configured (i) to receive content from one or more content providers through a content management user interface, and to store such content on the repository server for managed distribution to network clients, (ii) to collect and store on the repository server both static and dynamic user and client attributes, including behavioral history of users and clients, from the web traffic established by network users and clients during a plurality of web sessions, where the collecting of such attributes takes place throughout the entire web session and is not limited to monitoring of web traffic to a single website or to a single category of websites; and
a proxy server configured to proxy the web traffic of a network user and client during at least one web session and to decide whether to modify the web traffic, where the proxy server is further configured to modify the web traffic to include additional client-side code if a decision has been made to modify the web traffic, and then to deliver the modified web traffic to the client so that the client-side code may be executed so as to initiate a conversation between the client-side code and a web service configured to determine the most relevant content for the user, thereby matching relevant content on the network with a particular user based upon the user and/or client attributes;
wherein the private network is configured to present such relevant content to the user at least at one point throughout the web session regardless of the site being visited by the user or client at the time such relevant content is presented.
